(19) United States
(12) Patent Application Publication
(10) Pub. No.: US 2026/0356468 A1
(43) Pub. Date: Nov. 12, 2026

(54) NOISE-OPTIMIZED TORQUE INTRODUCTION

(71) Applicant: RENK GmbH, Augsburg (DE)

(72) Inventors: Ingo Sommer, Donauwoerth (DE); Michael Heider, Oberottmarshausen (DE); Maximillian Fromberger, Bobingen (DE); Andreas Beinstingel, Koenigsbrunn (DE)

(73) Assignee: RENK GmbH, Augsburg (DE)

(21) Appl. No.: 19/140,128

(22) PCT Filed: Dec. 19, 2023
(86) PCT No.: PCT/EP2023/086540

§ 371 Date: Jun. 17, 2025

(30) Foreign Application Priority Data
Dec. 20, 2022 (DE) 10 2022 214 050.8

(51) Int. Cl. B63H 23/02

(52) U.S. Cl. CPC B63H 23/02

(57) ABSTRACT

A gearwheel for a gearwheel stage of a transmission, in particular a marine transmission, includes a main gearing that extends axially between a main gearing start and a main gearing end; an interface; and a radial web for transmitting torque between the main gearing and the interface. The radial web is arranged in an axial portion of the gearwheel which lies between the main gearing start and the main gearing end; and/or the radial web is arranged between a first bearing for radial support, which extends axially from a first bearing start to a first bearing end, and a second bearing for radial support, which extends axially from a second bearing start to a second bearing end.

### CROSS-REFERENCE TO RELATED APPLICATIONS

This application is a national phase application under 35 U.S.C. § 371 of International Patent Application No. PCT/EP2023/086540, filed Dec. 19, 2023 (pending), which claims the benefit of priority to German Patent Application No. DE 10 2022 214 050.8, filed Dec. 20, 2022, the disclosures of which are incorporated by reference herein in their entirety.

### TECHNICAL FIELD

The present invention relates to a gearwheel for a gearwheel stage of a transmission, to a transmission, and to the use of a gearwheel.

### BACKGROUND

The operation of a transmission usually produces noise emissions, which can be stronger depending on the gearing, bearing quality, or the like. Typically, transmissions are optimized for a load case in which the transmission runs smoothly within predetermined limits.

### SUMMARY

It is an object of the invention to further improve noise production during operation of a transmission, in particular a gearwheel.

According to one embodiment of the invention, a gearwheel is provided for a gearwheel stage of a transmission, in particular a marine transmission. In one embodiment, the gearwheel comprises an interface. In one embodiment, the gearwheel comprises a main gearing which extends axially from a main gearing start to a main gearing end. In one embodiment, the gearwheel forms a radial web for transmitting torque between the main gearing and the interface. In one embodiment, the radial web is arranged axially between the main gearing start and the main gearing end. In one embodiment, the radial web is alternatively or additionally arranged axially between a first bearing for radial support, in particular a first bearing seat for a first bearing for radial support, which further extends in particular axially from a first bearing start to a first bearing end, and a second bearing for radial support, in particular a second bearing seat for a second bearing for radial support, which further extends in particular axially from a second bearing start to a second bearing end.

Advantageously, this makes it possible for a torque to be transmitted (more) quietly, in particular when there are more than two and/or more than three load points, in particular at least two load points.

In one embodiment, the radial web is axially spaced from the main gearing start by at least 10 percent, in particular at least 20 percent, in particular at least 30 percent, in particular at least 40 percent, and/or at most 45 percent of an axial distance between the main gearing start and the main gearing end. Alternatively or additionally, in one embodiment, the radial web is axially spaced from the main gearing end by at least 10 percent, in particular at least 20 percent, in particular at least 30 percent, in particular at least 40 percent, and/or at most 45 percent of an axial distance between the main gearing start and the main gearing end.

Alternatively or additionally, in one embodiment, the radial web is spaced from the first bearing by at least 10 percent, in particular at least 20 percent, in particular at least 30 percent, in particular at least 40 percent, and/or at most 45 percent of an axial distance between the first bearing and the second bearing.

Alternatively or additionally, in one embodiment, the radial web is spaced from the second bearing by at least 10 percent, in particular at least 20 percent, in particular at least 30 percent, in particular at least 40 percent, and/or at most 45 percent of an axial distance between the first bearing and the second bearing.

In one embodiment, the gearwheel extends from a gearwheel start to a gearwheel end, wherein the radial web is spaced from the gearwheel start by at least 10 percent, 20 percent, 30 percent or 40 percent of an axial distance between the gearwheel start and gearwheel end. In one embodiment, the main gearing start is additionally or alternatively axially spaced from the gearwheel start and/or the gearwheel end by at least 10 percent, 20 percent, 30 percent or 40 percent of an axial distance between the gearwheel start and gearwheel end.

Alternatively or additionally, in one embodiment, the main gearing end is additionally or alternatively axially spaced from the gearwheel start and/or the gearwheel end by at least 10 percent, 20 percent, 30 percent or 40 percent of an axial distance between the gearwheel start and gearwheel end.

Alternatively or additionally, in one embodiment, the gearwheel extends from a gearwheel start to a gearwheel end, wherein the radial web is spaced from the gearwheel end by at least 10 percent, 20 percent, 30 percent or 40 percent of an axial distance between the gearwheel start and gearwheel end. In one embodiment, the main gearing start is additionally or alternatively axially spaced from the gearwheel start and/or the gearwheel end by at least 10 percent, 20 percent, 30 percent or 40 percent of an axial distance between the gearwheel start and gearwheel end.

Alternatively or additionally, in one embodiment, the main gearing end is additionally or alternatively axially spaced from the gearwheel start and/or the gearwheel end by at least 10 percent, 20 percent, 30 percent or 40 percent of an axial distance between the gearwheel start and gearwheel end.

In one embodiment, the radial web is arranged in an axial portion of the gearwheel, in particular the axial portion is arranged between the axial end faces of the gearwheel at at least 20 percent and at most 80 percent, in particular at least 30 percent and at most 70 percent, in particular at least 40 percent and at most 60 percent, further in particular at least 45 percent and at most 55 percent, of the axial length of the gearwheel. Alternatively or additionally, in one embodiment, the axial portion is arranged between a first bearing for radial support, in particular a first bearing seat, and a second bearing for radial support, in particular a second bearing seat, of the gearwheel; in a portion of the gearwheel, in particular between the bearing points of the gearwheel at at least 20 percent and at most 80 percent, in particular at least 30 percent and at most 70 percent, in particular at least 40 percent and at most 60 percent, further in particular at least 45 percent and at most 55 percent, based on the axial spacing of the bearings, the bearing seats, and/or the bearing points. Alternatively or additionally, the axial portion is arranged in a portion of the main gearing, based on the axial length of the, in particular the entire, main gearing of the gearwheel at at least 20 percent and at most 80 percent, in particular at least 30 percent and at most 70 percent, in particular at least 40 percent and at most 60 percent, further in particular at least 45 percent and at most 55 percent, based on the axial length of the, in particular the entire, main gearing.

In one embodiment, the radial web is formed to transmit at least 50 percent, in particular at least 75 percent, in particular 100 percent, of the total, in particular maximum, torque that can be transmitted between the main gearing and the interface and/or of the total transmitted torque. Alternatively or additionally, in one embodiment the main gearing is formed to transmit at least 50 percent, in particular at least 75 percent, in particular 100 percent, of the total torque that can be transmitted by the gearwheel between the main gearing start and the main gearing end.

This advantageously makes it possible for the radial web, in particular the material of the radial web and/or the gearwheel, to be matched to the torque to be transmitted, in particular for the radial web to be adapted/formed for the torque to be transmitted.

In one embodiment, the radial web is arranged radially, in particular at least partially, within the main gearing. In one embodiment, the radial web is formed integrally with the gearwheel, in particular a part of the gearwheel, the main gearing and/or the interface, or is connected thereto in a positively fitting and/or friction-fitting manner, in particular via one or more radial web gearings, in particular axial and/or circumferential gearings, or is connected in a materially bonded manner. In one embodiment, the radial web is connected to the interface via a shaft, in particular in a positively fitting and/or a friction-fitting manner, in particular via one or more radial web gearings, in particular axial and/or circumferential gearings, or is connected in a materially bonded manner, wherein the shaft is arranged in particular radially within the main gearing.

In one embodiment, a radial web described herein is configured for transmitting, in particular exclusively, in particular introducing or discharging, a torque into the gearwheel, in particular into or from the main gearing of the gearwheel.

In one embodiment, the radial web and the gearwheel are mechanically operatively connected (to each other) without play and/or slippage.

In one embodiment, the radial web is axially fixed and/or stationary with respect to the gearwheel, in particular such that the radial web does not move axially when the gearwheel is at a standstill and/or during operation, in particular is fixed and/or axially stationary at its axial position with respect to the gearwheel.

In one embodiment, the radial web fills the axial portion at least substantially. In one embodiment, the radial web is formed such that the axial portion is at least substantially filled.

In one embodiment, the radial web is formed radially in the axial portion at least substantially up to the axis of rotation. In one embodiment, the radial web is formed such that at least a part of the radial web intersects the axis of rotation and/or comprises at least one common point with the axis of rotation.

The term “radial web,” as used herein, is to be understood in particular as a web formed in the corresponding (axial) portion, from which a torque is first guided radially inwards, in particular in the direction of the axis of rotation of the gearwheel, and then axially out of the gearwheel or vice versa, in particular without any further mechanical operative connection with the gearwheel during the outward guidance. In one embodiment, the radial web is formed (only) in portions, in particular with respect to a circumferential direction. In one embodiment, the radial web is formed in multiple pieces.

In some embodiments, the gearwheel is, at least substantially, symmetrical in its dimensions.

Advantageously, in one embodiment, it can be made possible for bending and torsion of the gearwheel under load to be advantageously superimposed in such a way that they at least substantially reduce one another and/or cancel one another out. In one embodiment, this makes it possible to reduce noise generated by the transmission, in particular the gearwheel, in particular when there are more than two, in particular more than three, load points.

In one embodiment, the gearwheel is formed such that the torque is introduced into the gearwheel centrally, in particular in an axial portion described herein.

Advantageously, in one embodiment, this can reduce a correction of the flank line of a gear tooth. Furthermore, in one embodiment, a correction of the crowning can advantageously be reduced. In particular, in one embodiment noise emissions during operation can be reduced, in particular when there are more than two load points. Advantageously, in one embodiment a torque can be transmitted (more) quietly.

The term “central” or “in the center” as used herein is to be understood in particular as an axial portion of the gearwheel which is located between the axial end faces of the gearwheel at at least 20 percent and at most 80 percent, in particular at least 30 percent and at most 70 percent, in particular at least 40 percent and at most 60 percent, further in particular at least 45 percent and at most 55 percent, of the axial length of the gearwheel; alternatively or additionally, this is to be understood in particular as an axial portion of the gearwheel which is located between a first bearing and a second bearing for radial support of the gearwheel, based on the axial spacing of the bearings, at at least 20 percent and at most 80 percent, in particular at least 30 percent and at most 70 percent, in particular at least 40 percent and at most 60 percent, further in particular at least 45 percent and at most 55 percent; alternatively or additionally, this is to be understood in particular as an axial portion of the gearwheel which, in the main gearing, based on the axial length of the (entire) main gearing of the gearwheel, in particular of the (entire) main gearing on the gearwheel, is located at at least 20 percent and at most 80 percent, in particular at least 30 percent and at most 70 percent, in particular at least 40 percent and at most 60 percent, further in particular at least 45 percent and at most 55 percent, based on the axial length of the (entire) main gearing.

In one embodiment, the gearwheel comprises two or more parts or is composed of two or more parts. In one embodiment, the main gearing is distributed over the two or more parts, in particular uniformly or in particular in equal parts. In one embodiment, the main gearing comprises a first main gearing part which extends between the main gearing start and a gearing part end, and at least one further main gearing part which extends between a gearing part start, spaced from the gearing part end and the main gearing end. In one embodiment, the main gearing can be formed as a double helical gearing.

In one embodiment, this can enable the operation of a transmission comprising a gearwheel described herein to be quiet(er), in particular across multiple load points.

In one embodiment, the two or more parts of the gearwheel are connected to each other in a materially bonded, positively connected and/or non-positively connected manner. In one embodiment, the two or more parts of the gearwheel can in particular be welded to one another and/or operatively connected via a gearing, in particular via a gearing that is clamped (to one another) by a screw connection and/or via a clamping sleeve.

In one embodiment, the gearwheel, in particular the two or more parts of the gearwheel, are connected to the radial web in a materially bonded, positively connected and/or non-positively connected manner. In one embodiment, the gearwheel, in particular the two or more parts of the gearwheel, are connected to the radial web and/or the interface in a materially bonded, positively connected and/or non-positively connected manner. In one embodiment, the radial web and the interface are connected in a materially bonded positively connected and/or non-positively connected manner.

In one embodiment, the gearwheel comprises a radial web, in particular centrally, further in particular in the axial portion, as described herein. In other words, in one embodiment by means of the radial web a torque is introduced into the gearwheel centrally to the gearwheel, centrally between the bearings and/or centrally to the main gearing or centrally with respect to the main gearings.

In one embodiment, the gearwheel, the radial web and/or the interface comprise a gearing which differs in particular from the main gearing for introducing and/or receiving the torque; in particular, the gearwheel, the radial web and/or the interface are (operatively) connected by the gearing.

Advantageously, this allows torque to be introduced or transmitted centrally in a (more) space-saving manner.

In one embodiment, the gearwheel comprises a hollow shaft comprising an internal gearing and a one-part or multi-part internal shaft which connects the radial web to the interface, in particular integrally. In one embodiment, the internal shaft is arranged in the in particular one-part or multi-part hollow shaft on which the main gearing is arranged. In one embodiment, the radial web is formed by the internal gearing and the external gearing, in particular an internal gearing and an external toothing according to DIN5480, in particular in order to transmit a torque. In one embodiment, the internal gearing of the gearwheel is formed centrally (as described herein), so that the torque acts centrally on the gearwheel or is transmitted by it; in particular, in one embodiment the gearwheel (with its internal gearing) and the shaft (with its external gearing) form the radial web (as described herein), so that the torque acts via the radial web, as described herein.

Advantageously, in this way in one embodiment a torque can (more) easily act centrally on the gearwheel, or be transmitted to or from it.

In one embodiment, the radial web is formed as a separate part which is in (mechanical) operative connection with the gearwheel, in particular its parts, in particular at least a part of the gearwheel or all parts of the gearwheel.

In one embodiment, the gearwheel and the radial web are screwed together. In one embodiment, the two or more parts of the gearwheel, in particular a first part and a second part of the gearwheel, and the radial web are clamped together, in particular screwed or clamped via a clamping sleeve.

In one embodiment, the radial web comprises one or more parts and/or is composed of a plurality of parts.

In one embodiment, the at least two parts of the gearwheel are (operatively) connected to one another by Hirth coupling. In one embodiment, the gearwheel, in particular at least one of the parts of the gearwheel, and the radial web are (operatively) connected to one another by Hirth coupling.

In one embodiment, the gearwheel is operatively connected to the interface by a Hirth coupling. In one embodiment, the first part of the gearwheel is operatively connected to the interface by a Hirth coupling and/or the second part of the gearwheel is (operatively) connected to the interface by a Hirth coupling.

In one embodiment, the parts of the gearwheel are connected by a Hirth coupling. Alternatively or additionally, in one embodiment the radial web is connected to at least one part of the gearwheel by Hirth coupling in such a way that the torque is transmitted to the gearwheel, in particular the first and/or the second part of the gearwheel. In other words, in one embodiment the radial web is connected to the gearwheel, in particular to the first and/or the second part of the gearwheel, by Hirth coupling, in such a way that the torque is transmitted via the radial web, in particular centrally, to or from the gearwheel.

In one embodiment, this advantageously makes it possible for the gearwheel to be made (more) compact and, in particular, for a torque to be transmitted (more) quietly, in particular when there are at least two load points.

In one embodiment, the main gearing of the gearwheel is a double helical gearing, or is formed as such. In one embodiment, the main gearing is a herringbone gearing, or is formed as such.

In one embodiment, the radial web can correspond to the interface or be a/the interface and/or can be configured together with the interface to transmit a torque.

In one embodiment, a gearwheel described herein, in particular a transmission described herein which comprises at least one gearwheel described herein, enables the gearwheel, in particular the transmission, to be formed or used for quiet(er) operation, in particular when there are two or more load points for the gearwheel/transmission, in particular in a marine transmission.

In one embodiment of the invention, a method is provided for manufacturing a gearwheel, in particular a gearwheel described herein. In one embodiment, the method comprises manufacturing the main gearing. In one embodiment, the method comprises forming a radial web, in particular by shaping and/or machining processing, further in particular by generative methods. In one embodiment, the method comprises connecting the radial web and the, in particular at least one, gearwheel body of the gearwheel using materially bonding connection methods, frictional connection methods and/or positive connection methods, in particular by clamping a Hirth coupling on the parts, in particular on the radial web and on the gearwheel body. In one embodiment, the method comprises connecting the radial web and the interface using materially bonding connection methods, frictional connection methods and/or positive connection methods, in particular by clamping a Hirth coupling on the parts, in particular on the radial web and on the interface.

The terms “comprises,” “contains,” “includes,” “has,” “with,” or any other variants thereof, as used herein, are intended to cover a non-exclusive inclusion. For example, a method or device that includes or comprises a list of elements is not necessarily limited to these elements, but may include other elements that are not expressly listed or that are inherent to such a method or device.

Furthermore, unless the contrary is expressly stated, “or” refers to an inclusive “or” and not an exclusive “or.” For example, a condition A or B is satisfied by one of the following conditions: A is true (or present) and B is false (or absent), A is false (or absent) and B is true (or present), and both A and B are true (or present).

The terms “a” or “an” as used herein are defined to mean “one or more.” The terms “another” and “a further” and any other variant thereof are to be understood in the sense of “at least one further.”

The term “configured” or “set up” to perform a particular function (and variations thereof), as used herein, is to be understood as meaning that a relevant device or component thereof is already in a configuration or setting in which it can perform the function, or at least can be adjusted—i.e., can be configured—in such a way that it can perform the function after being adjusted accordingly. The configuration can be carried out for example by setting the parameters of a process sequence or by using switches or the like to activate or deactivate functionalities or settings.

According to one embodiment of the invention, a transmission, in particular a marine transmission, is provided, wherein the transmission comprises at least one gearwheel stage with at least one gearwheel described herein.

The term “marine” is to be understood herein as referring preferably to a watercraft or waterborne vehicle, in particular a motor-driven ship, such as, without restriction of generality, in particular a submarine.

In this way, a use, in particular a journey, can advantageously be made quiet(er), in particular when there are a plurality of load points.

Embodiments, in particular their features, as described herein can each be combined as desired with one another and with the further described embodiments of the present solution, unless this is expressly excluded or technically impossible.

The features and advantages explained in relation to the one embodiment of the invention also apply accordingly to the further embodiments of the invention.

Further advantages, features and possible applications of the present invention emerge from the following detailed description in connection with the figures.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically shows a gearwheel for a gearwheel stage of a transmission in one embodiment;

FIG. 2 schematically shows a gearwheel for a gearwheel stage of a transmission in one embodiment;

FIG. 3 schematically shows a gearwheel for a gearwheel stage of a transmission in one embodiment;

FIG. 4 schematically shows a gearwheel for a gearwheel stage of a transmission in one embodiment;

FIG. 5 schematically shows a gearwheel for a gearwheel stage of a transmission in one embodiment; and

FIG. 6 schematically shows a gearwheel for a gearwheel stage of a transmission in one embodiment.

### DETAILED DESCRIPTION

In the figures, identical reference signs denote identical, similar or corresponding elements. The hundreds digit of the reference sign refers to (different) embodiments, and the following digits refer to identical, similar or corresponding elements. Elements shown in the figures are not necessarily to scale. Rather, the various elements shown in the figures are reproduced in such a way that their function and general purpose are made understandable to a person skilled in the art. Connections and couplings between functional units and elements shown in the figures can also be implemented as indirect connections or couplings, unless expressly stated otherwise.

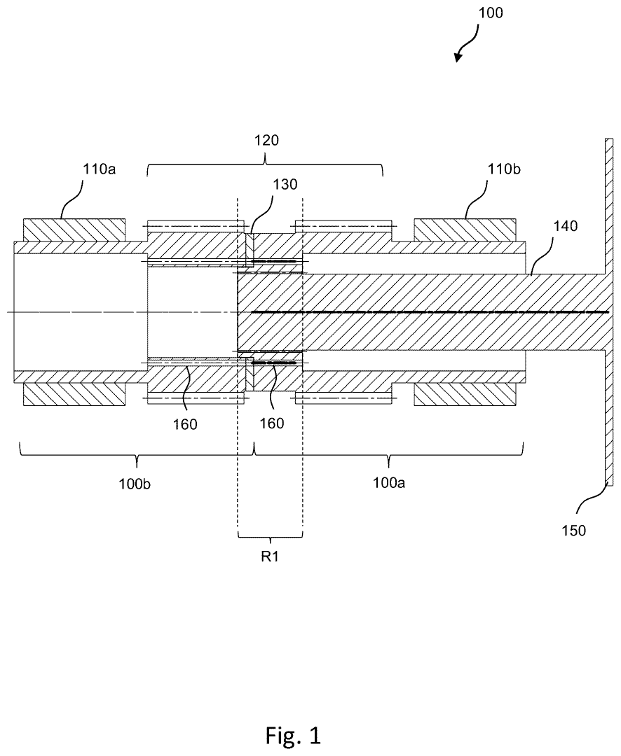

FIG. 1 schematically shows an exemplary gearwheel 100 for a gearwheel stage of a transmission in accordance with the principles of the present disclosure. The gearwheel 100 in FIG. 1 comprises two parts 100a, 100b, each part being or being able to be supported by radial bearings 110a, 110b. The gearwheel 100 comprises a main gearing 120, which in the embodiment shown is divided between the two parts of the gearwheel 100, in FIG. 1 in equal parts by way of example. The main gearing 120 is formed as a double helical gearing. In FIG. 1, the parts 100a and 100b are axially operatively connected to one another by a Hirth coupling 130. Furthermore, the gearwheel 100 comprises an internal gearing which is operatively connected to the shaft, which in the embodiment in FIG. 1 is formed in portions as a splined shaft, forms a radial web. A torque is or can be introduced or transmitted via an interface 150. Furthermore, the parts 100a, 100b of the gearwheel 100 in FIG. 1 are screwed together and comprise corresponding bores 160 for this purpose. The parts 100a, 100b of the gearwheel 100 are formed such that the transmitted torque acts centrally on the gearwheel 100. The gearwheel 100 forms (for this purpose), together with in particular the external gearing of the shaft 140, a radial web R1 via which, in particular centrally, a torque can be or is introduced into the gearwheel 100 or from which torque can be or is transmitted from the gearwheel 100 to the interface 150.

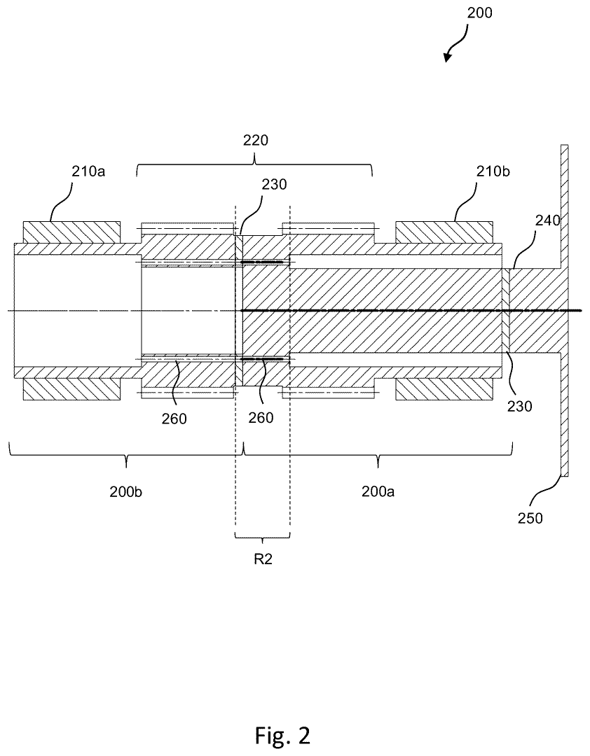

FIG. 2 schematically shows a gearwheel 200 for a gearwheel stage of a transmission in one embodiment. The gearwheel 200 is formed from two parts 200a, 200b, which are axially operatively connected to one another by a Hirth coupling 230. The main gearing 220 is shown distributed over the two parts 200a, 200b, wherein the first part 200a, shown on the right, is formed such that a torque is transmitted via a shaft 240 on the first part 200a, in one embodiment in particular by a (further) Hirth coupling 230 which is operatively connected to an interface 250. Furthermore, FIG. 2 shows bores 260 which are formed for a screw connection of the parts 200a and 200b of the gearwheel 200. For this purpose, the part 200a is further cut out in such a way that the torque is introduced centrally into the gearwheel 200. Furthermore, FIG. 2 shows the radial web R2 formed by the first part 200a of the gearwheel 200 via which, in particular exclusively, torque is transmitted, in particular from the gearwheel 200 to the interface 250 or vice versa. Radial bearings 210a, 210b are also shown.

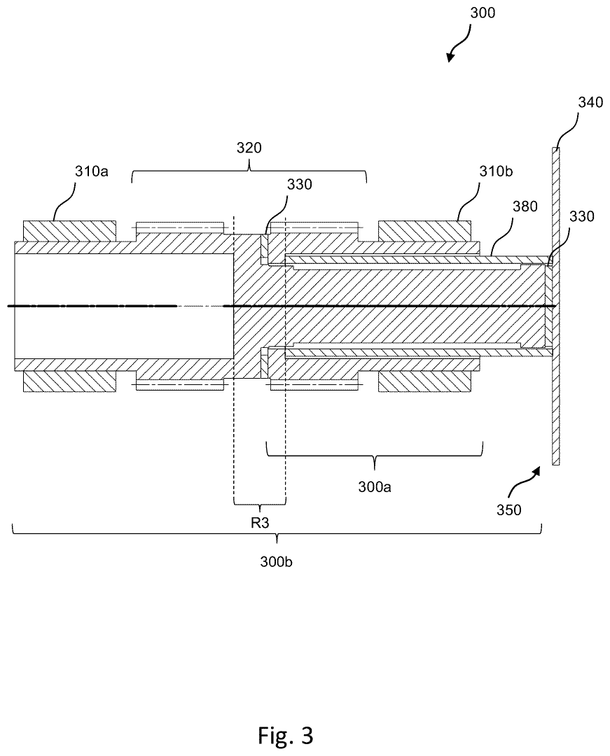

FIG. 3 schematically shows a gearwheel 300 for a gearwheel stage of a transmission in one embodiment. For this purpose, the gearwheel 300 comprises two parts 300a and 300b, wherein the second part 300b, shown on the left, is partially formed as a shaft which passes through the first part 300a to the right or on which the first part 300a is attached. The two parts 300a, 300b are operatively connected to each other by a Hirth coupling 330. Furthermore, the main gearing 320 is divided between the two parts. An interface 350 is shown on the right side and is operatively connected to the second part 300b in such a way that the torque acts centrally in the gearwheel 300, in particular in one embodiment with the aid of a (further) Hirth coupling 330. FIG. 3 further shows a sleeve 380 for clamping the Hirth coupling 330, or that the Hirth coupling is clamped by the sleeve 380. In FIG. 3, the second part 300b of the gearwheel 300 forms a radial web R3 via which torque is transmitted. Radial bearings 310a, 310b are also shown.

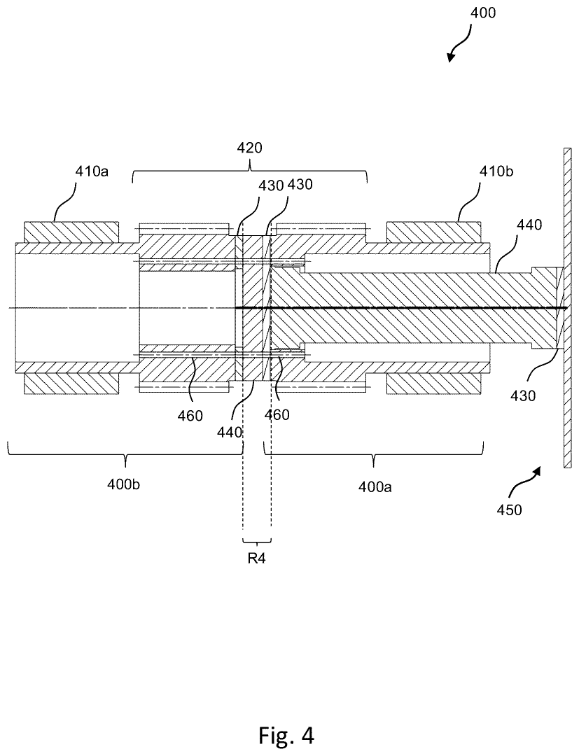

FIG. 4 schematically shows a gearwheel 400 for a gearwheel stage of a transmission in another embodiment. The gearwheel 400 comprises two parts 400a and 400b, which are connected to or via a radial web R4 by Hirth couplings 430. The radial web R4 is arranged centrally between the parts 400a and 400b of the gearwheel 400. Furthermore, the radial web is connected to an interface 450 via a shaft 440 through the first part 400a of the gearwheel 400. In FIG. 4, the shaft 440 is connected to the interface 450 by a (further) Hirth coupling 430, via which a torque can be or is transmitted that acts centrally in the gearwheel 400. In FIG. 4, the radial web R4 is (operatively) connected to the interface 450 by the shaft 440. Furthermore, FIG. 4 shows bores 460 which are formed for a screw connection of the parts 400a and 400b of the gearwheel 400. Radial bearings 410a, 410b are also shown.

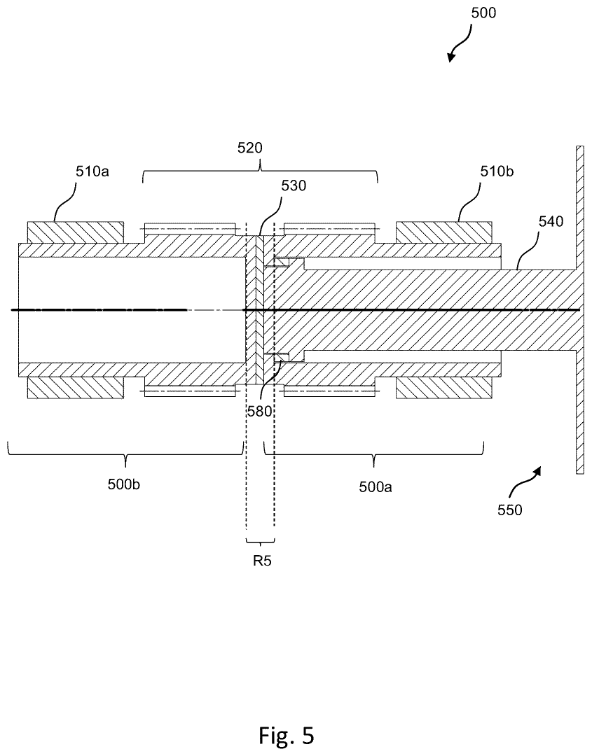

FIG. 5 schematically shows a gearwheel 500 for a gearwheel stage of a transmission in another embodiment. The gearwheel 500 is formed in two parts 500a and 500b, which are operatively connected to each other by a Hirth coupling 530. Furthermore, a shaft 540 acts centrally on the gearwheel 500, clamps the parts 500a, 500b of the gearwheel 500 using a sleeve 580, and is operatively connected to the gearwheel 500 via the Hirth coupling 530. The main gearing 520 is uniformly distributed between the two parts 500a, 500b and the gearwheel 500 can be supported by the radial bearings 510a, 510b shown, in particular in a transmission. Furthermore, an interface 550 is shown schematically which serves or is configured to transmit a torque. FIG. 5 shows a radial web R5 which is formed by the first part 500a and the second part 500b of the gearwheel 500 and parts of the connection between the radial web R5 and the interface 550, in particular by a part of the shaft 540.

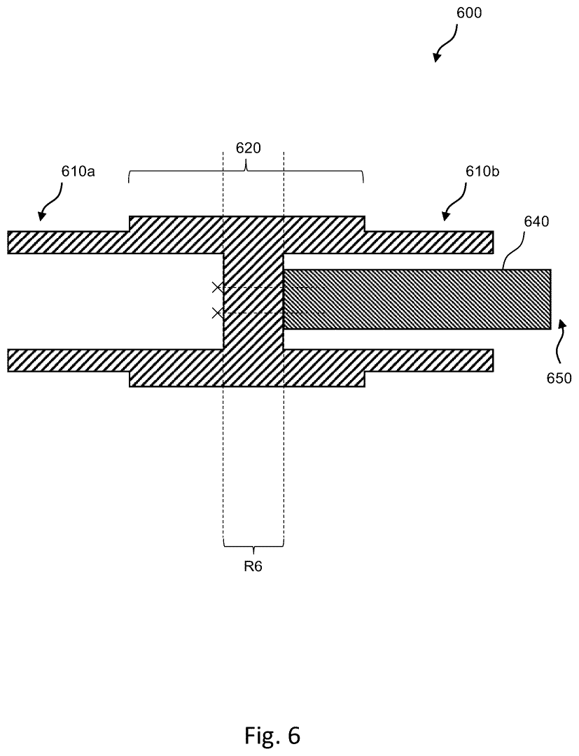

FIG. 6 schematically shows a gearwheel 600 for a gearwheel stage of a transmission in one embodiment. The gearwheel 600 is made in one piece and (itself) forms a radial web R6. In the embodiment shown schematically, the radial web R6 is screwed to a shaft 640 via which a torque is transmitted, in particular exclusively, to the interface 650 or the gearwheel 600. The torque is not transmitted via the gearwheel 600 (directly) to the interface 650 (not shown), but is transmitted, in particular exclusively, via the radial web R6 and the shaft 640. In this way, in particular a (central) introduction of torque into the gearwheel 600 is determined, in particular via the axial portion in which the radial web R6 is arranged or formed. Furthermore, a main gearing 620 is shown, as well as the bearing seats for radial bearings 610a, 610b. A connection of gearwheel 600 to the interface, in particular of radial web R6 and shaft 640, can in some embodiments also be materially bonded and/or positively connected, in particular by Hirth coupling. In one embodiment, the gearwheel 600, in particular its main gearing 620, comprises a double helical gearing.

While at least one embodiment has been described above, it should be understood that a large number of variations exist therefor. It should also be noted that the embodiments described represent only non-limiting examples, and it is not intended to limit the scope, applicability, or configuration of the devices and methods described herein. Rather, the preceding description will provide a person skilled in the art with instructions for implementing at least one exemplary embodiment, it being understood that various changes in the mode of operation and the arrangement of the elements described in an exemplary embodiment can be made without departing from the subject matter specified in each case in the appended claims, as well as the legal equivalents thereof.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

100, 200, 300, 400, 500, 600 Gearwheel
100a, 200a, 300a, 400a, 500a, First part of the gearwheel
100b, 200b, 300b, 400b, 500b Second part of the gearwheel
110a, 110b, 210a, 210b, 310a, Bearing
310b, 410a, 410b, 510a, 510b
120, 220, 320, 420, 520, 620 Main gearing
130, 230, 330 430, 530 Hirth coupling
140, 240, 340, 440, 540, 640 Shaft
150, 250, 350, 450, 550, 650 Interface
160, 260, 460 Bore
380,580 Sleeve
R1-R6 Radial web

What is claimed is:

1-10. (canceled)

11. A gearwheel for a gearwheel stage of a transmission, in particular a marine transmission, the gearwheel comprising:
a main gearing extending axially between a main gearing start and a main gearing end;
an interface for transmitting or receiving torque; and
a radial web for transmitting torque between the main gearing and the interface;
wherein at least one of:
the radial web is arranged in an axial portion of the gearwheel that lies between the main gearing start and the main gearing end, or
the radial web is arranged between a first radial bearing seat and a second radial bearing seat, the first bearing seat extending axially from a first bearing start to a first bearing end, and the second bearing seat extending axially from a second bearing start to a second bearing end.

12. The gearwheel of claim 11, wherein at least one of:
the radial web is axially spaced from at least one of the main gearing start or main gearing end by at least 10 percent of an axial distance between the main gearing start and the main gearing end; or
the radial web is axially spaced from at least one of the first bearing seat or the second bearing seat by at least 10 percent of an axial distance between the first and the second bearing seat.

13. The gearwheel of claim 12, wherein at least one of:
the radial web is axially spaced from at least one of the main gearing start or main gearing end by at least 30 percent of an axial distance between the main gearing start and the main gearing end; or
the radial web is axially spaced from at least one of the first or second bearing seat by at least 30 percent of an axial distance between the first and the second bearing seat.

14. The gearwheel of claim 11, wherein at least one of:
the radial web is formed to transmit at least 50 percent of the total torque that can be transmitted between the main gearing and the interface; or
the main gearing is formed to transmit at least 50 percent of the total torque that can be transmitted by the gearwheel between the main gearing start and the main gearing end.

15. The gearwheel of claim 14, wherein at least one of:
the radial web is formed to transmit at least 100 percent of the total torque that can be transmitted between the main gearing and the interface; or
the main gearing is formed to transmit at least 100 percent of the total torque that can be transmitted by the gearwheel between the main gearing start and the main gearing end.

16. The gearwheel of claim 11, wherein at least one of:
the radial web is arranged radially at least partially within the main gearing; or
the radial web is one of:
formed integrally with at least one of the main gearing or the interface,
connected with at least one of the main gearing or the interface in at least one of a positively fitting or friction-fitting manner, or
connected with at least one of the main gearing or the interface in a materially bonded manner.

17. The gearwheel of claim 16, wherein the radial web is connected with at least one of the main gearing or the interface in a positively fitting and/or friction-fitting manner via one or more radial web gearings.

18. The gearwheel of claim 17, wherein the one or more radial web gearings are at least one of axial gearings or circumferential gearings.

19. The gearwheel of claim 11, wherein:
the gearwheel comprises two or more parts; and
the main gearing is distributed over the two or more parts.

20. The gearwheel of claim 11, further comprising:
a hollow shaft;
wherein the main gearing of the gearwheel is arranged externally on the hollow shaft; and
an inner shaft connecting the radial web to the interface;
wherein the inner shaft is arranged in the hollow shaft.

21. The gearwheel of claim 11, wherein the main gearing comprises:
a first main gearing part extending between the main gearing start and a main gearing part end; and
at least one second main gearing part extending between a main gearing part start, spaced from the main gearing part end, and the main gearing end.

22. The gearwheel of claim 19, wherein a first part of the gearwheel is connected to at least one second part of the gearwheel in one of:
at least one of a positively fitting or friction-fitting manner; or
in a materially bonded manner.

23. The gearwheel of claim 22, wherein the first part of the gearwheel is connected to the at least one second part of the gearwheel in a positively fitting and/or friction-fitting manner via one or more radial web gearings.

24. The gearwheel of claim 23, wherein the one or more radial web gearings are at least one of axial gearings or circumferential gearings.

25. The gearwheel of claim 24, wherein the one or more radial web gearings are axial gearings comprising at least one Hirth coupling.

26. A transmission, in particular marine transmission, comprising:
at least one gearwheel stage including at least one gearwheel;
the at least one gearwheel comprising:
a main gearing extending axially between a main gearing start and a main gearing end,
an interface for transmitting or receiving torque, and
a radial web for transmitting torque between the main gearing and the interface;
wherein at least one of:
the radial web is arranged in an axial portion of the gearwheel that lies between the main gearing start and the main gearing end, or
the radial web is arranged between a first radial bearing seat and a second radial bearing seat, the first bearing seat extending axially from a first bearing start to a first bearing end, and the second bearing seat extending axially from a second bearing start to a second bearing end.
